(19) United States
(12) Patent Application Publication
(10) Pub. No.: US 2010/0189471 A1
(43) Pub. Date: Jul. 29, 2010

(54) IMAGE FORMING APPARATUS AND DEVELOPER COLLECTING METHOD OF THE IMAGE FORMING APPARATUS

(75) Inventor: Keiji Yuge, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/695,263

(22) Filed: Jan. 28, 2010

Related U.S. Application Data
(60) Provisional application No. 61/148,170, filed on Jan. 29, 2009.

(51) Int. Cl. G03G 15/095

(52) U.S. Cl. 399/264

(57) ABSTRACT

An image forming apparatus includes a cleaning unit including a cleaning blade which contacts with an image carrier and peels a collected material on the image carrier, and an auger to convey the peeled collected material in a direction parallel to a rotation axis of the image carrier. The auger includes an axial body to rotate around a rotation axis parallel to the rotation axis of the image carrier, a spiral conveyance portion spirally provided on an outer peripheral curved surface of the axial body, and a conveyance portion. The conveyance portion includes a base portion extending in a lateral direction, and plural vane portions provided to be spaced from each other at specified intervals in a longitudinal direction of the base portion.

### CROSS-REFERENCE TO RELATED APPLICATIONS

This application is based upon and claims the benefit of priority from the prior U.S. Patent Application No. 61/148,170, filed on 29 Jan., 2009, the entire contents of which are incorporated herein by reference.

### TECHNICAL FIELD

The present invention relates to an image forming apparatus, such as a copying machine, and a developer collecting method of the image forming apparatus, and particularly to an image forming apparatus in which the collection efficiency of a developer is improved and a developer collecting method of the image forming apparatus.

### BACKGROUND

In an image forming apparatus such as a printer, an electrostatic latent image of a developer such as toner is formed on an image carrier such as a photoconductive drum, and the electrostatic latent image is fixed to a recording medium such as a sheet by a transfer device.

In this type of image forming apparatus, a cleaning device collects the not-transferred developer on the image carrier and paper powder. The cleaning device includes a cleaning blade and an auger. The cleaning blade peels the developer and paper powder on the image carrier, and the auger conveys the peeled developer and paper powder to a waste developer container or a developing unit.

Recently, recycle paper is used as a recording medium. In the recycle paper, a lot of paper powder can occur. The paper powder deteriorates the fluidity of the collected developer. Besides, when the developer is recycled for a long period, the fluidity deteriorates.

Accordingly, the fluidity of the developer collected by the cleaning device is poor. Especially, the paper powder is nipped by the edge of the cleaning blade and causes the defective cleaning. Besides, the paper powder is retained at the edge of the cleaning blade, prevents the toner collection, and causes toner dropping.

Especially, recently, an image forming apparatus main body is miniaturized, and a cleaning device of a developing unit to supply a developer to an image carrier is disposed above the rotation axis of the image carrier. In such a type, the foregoing problem remarkably arises.

In this point, JP-A-2009-134169 discloses a technique in which a vane portion to rotate around a rotation axis parallel to a rotation axis of an image carrier is provided, and waste material is conveyed.

However, this technique has a problem that the machine body becomes large, and the manufacture cost is increased.

JP-A-2007-147716 discloses a technique in which an auger is provided with a paddle member, accumulated developer is supplied to a cleaning blade to replace developer in the vicinity of the cleaning blade, and the occurrence of a condensed lump of developer is prevented.

However, in this technique, since the replacement of the developer accumulated at the cleaning blade is performed by the developer, there is a problem that the replacement becomes insufficient, and it can not be avoided that the condensed lump is generated.

Further, there is a problem that when this technique is applied to a model in which a cleaning device is disposed above the rotation axis of an image carrier, the cleaning effect can not be sufficiently obtained.

### SUMMARY

It is an object of the present invention to provide an image forming apparatus and a developer collecting method of the image forming apparatus, in which the collection efficiency of a developer is improved.

In an aspect of the present invention, an image forming apparatus includes

an image carrier to carry an electrostatic latent image,

a developing unit to supply a developer to the image carrier, and

a cleaning unit which includes a cleaning blade to contact with the image carrier and to peel the developer, an auger including a spiral conveyance portion formed into a spiral shape and to convey the developer peeled by the cleaning blade, and plural conveyance portions provided in the auger, having plural vane portions provided to be spaced from each other at specified intervals in a longitudinal direction of a base portion extending in a longitudinal direction of the auger, and having a length to contact with the cleaning blade, and is placed above a rotation axis of the image carrier.

### DESCRIPTION OF THE DRAWINGS

FIG. 1 is a front schematic view of a state where a cover of an image forming apparatus is removed.

FIG. 2 is a side sectional view of an image forming portion.

FIG. 3 is an enlarged sectional view of a cleaning unit.

FIG. 4 is an enlarged side view of an auger.

FIG. 5 is an enlarged perspective view of the auger.

FIG. 6 is a sectional view of the auger taken along line A-A in FIG. 5.

FIG. 7 is a sectional view of the auger taken along line A-A in FIG. 5.

FIG. 8 is a front view and a sectional view of a conveyance portion.

FIG. 9 is a view showing a relation between a cut angle θ2 and a conveyance force of a collection developer.

FIG. 10 is a view showing the placement range of the conveyance portion provided in the auger.

FIG. 11 is a sectional view of the auger.

FIG. 12 is a sectional view of the periphery of the auger.

FIG. 13 is a view showing a relation between the length of each part of the conveyance portion and the thickness.

FIG. 14 is a view showing the operation of the auger in the optimum range in FIG. 13.

FIG. 15 is a view showing an example of application to a cleaning unit of an image forming apparatus including an intermediate transfer body.

### DETAILED DESCRIPTION

Throughout this description, the embodiments and examples shown should be considered as exemplars, rather than limitations on the apparatus and methods of the present invention.

Hereinafter, an embodiment of an image forming apparatus of the invention will be described in detail with reference to the drawings.

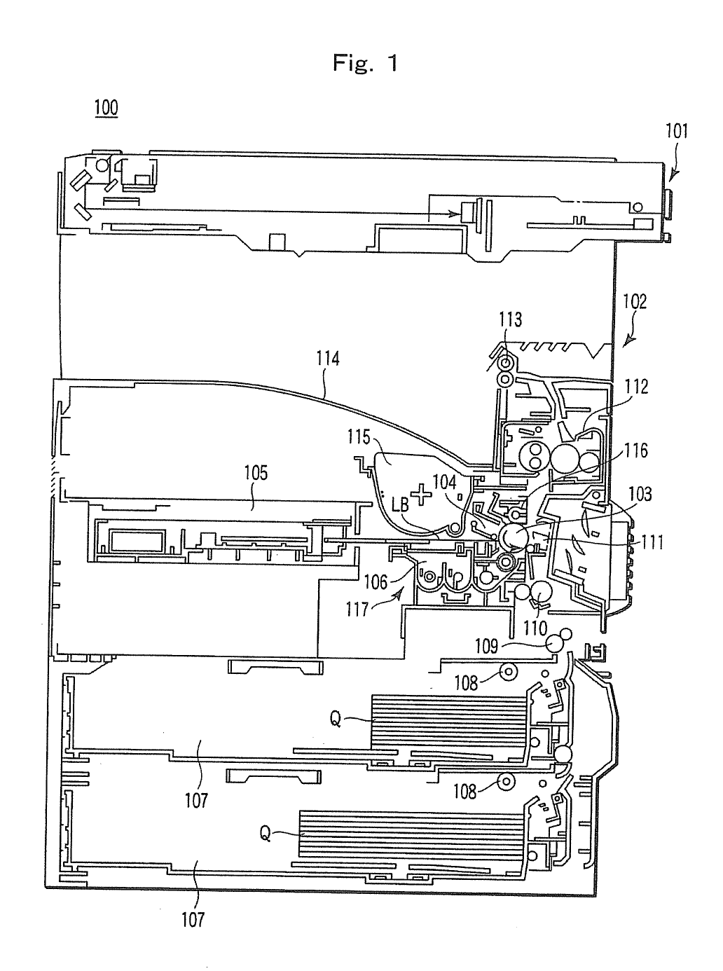

FIG. 1 is a front schematic view of a state where a cover of an image forming apparatus is removed. As shown in FIG. 1, an image forming apparatus (digital copying apparatus) 100 includes an image reading device 101 to read or to read copying target (original document) image to generate an image signal, and an image forming portion 102 to form an image based on an image signal outputted by the image reading device 101 or an image signal provided from the outside.

The image forming portion 102 includes a photoconductive drum as an image carrier 103, an electric discharge unit 104, an exposure device 105, a developing unit 106, a sheet cassette 107, a pickup roller 108, a conveyance roller 109, an aligning roller 110, a transfer device 111, a fixing device 112, a paper discharge roller 113, a paper discharge tray 114, a fresh toner replenish device 115 and a cleaning unit 116.

The image carrier 103 includes, on an outer peripheral surface, a photoreceptor in which when light is irradiated in a state where a specified potential is given, the potential of a region irradiated by the light is changed, and the change of the potential is held as an electrostatic latent image for a specified time. Incidentally, the photoreceptor may have a belt shape in place of the drum shape.

The electric discharge unit 104 charges the surface of the image carrier 103 to a specified potential. Incidentally, the discharge unit 104 may be a corona wire, a contact roller or a contact blade.

The exposure device 105 is positioned at the downstream side of the electric discharge unit 104 in the rotation direction of the image carrier 103, and exposes the image carrier 103 with a laser beam LB whose light intensity is changed correspondingly to the image signal supplied from the scanner 101. Incidentally, the laser beam LB can have the specified light intensity corresponding to the density or the like of an image. The exposure device 105 may use an LED instead of the laser.

The developing unit 106 is positioned at the downstream side of the exposure device 105 in the rotation direction of the image carrier 103, contains a two-component developer including a carrier and a toner, and supplies the developer (toner) to the surface of the image carrier 103. The latent image on the surface of the image carrier 103 is visualized and a developer image is formed. Incidentally, the developer may be a one-component developer including only toner.

The sheet cassette 107 contains a sheet Q, the pickup roller 108 takes out it one by one, and the sheet Q is conveyed to the aligning roller 110 by the conveyance roller 109.

The aligning roller 110 rotates at a specified timing so as to align the position of the sheet Q and the toner image formed on the image carrier 103, and conveys the sheet Q to a transfer position.

The transfer device 111 gives a specified potential to the sheet Q, and transfers the toner image on the image carrier 103 to the sheet Q.

The fixing device 112 gives specified heat and pressure to the sheet Q holding the toner image, and sticks (fixes) the melted toner image to the sheet Q.

The paper discharge roller 113 conveys the sheet Q discharged from the fixing device 112 to the paper discharge tray 114.

The fresh toner replenish device 115 supplies fresh toner (non-used developer) not used for image formation to the developing unit 106 at a specified timing.

The cleaning unit 116 is positioned at the downstream side of the transfer position where the image carrier 103 faces the transfer device 111 in the rotation direction of the image carrier 103, and collects the toner adhered on the surface of the image carrier 103. The cleaning unit 116 includes, for example, a cleaning blade or a rotation brush which contacts with the image carrier 103.

An image forming portion 117 includes the image carrier 103, the electric discharge unit 104, the developing unit 106, and the cleaning unit 116. The developing unit 106 is attachable to and detachable from the image forming apparatus 100 main body.

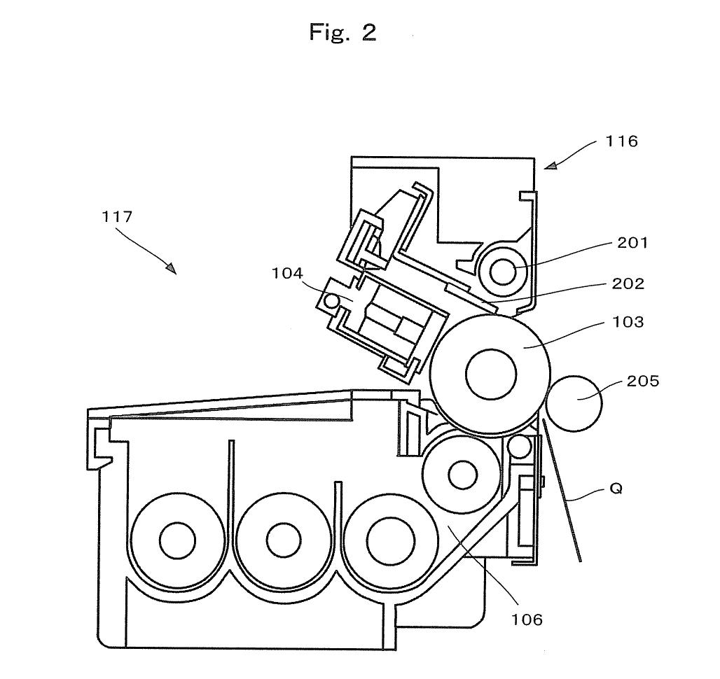

FIG. 2 is a side sectional view of the image forming portion 117. As shown in FIG. 2, the image forming portion 117 includes the developing unit 106 to supply the developer such as toner to the image carrier 103 which is a photoconductive drum or an intermediate transfer body, and the cleaning unit 116 to collect the developer, which is not transferred onto the image carrier 103, and paper powder (hereinafter referred to as collected material).

The cleaning unit 116 includes a cleaning blade 202 which contacts with the image carrier 103 and peels the collected material on the image carrier 103, and an auger 201 to convey the peeled collected material in a direction parallel to a rotation axis of the image carrier 103.

The cleaning blade 202 is made of urethane rubber.

The image carrier 103 is given voltage by the electric discharge unit 104 and is charged. An electrostatic latent image is formed on the charged image carrier 103 by the laser light emitted from a not-shown laser light source.

The developing unit 106 supplies the developer to the image carrier 103. A developer image is formed on the image carrier 103. The developer image is transferred to the recording medium Q by the transfer roller 205. The not-shown fixing device fixes the transferred developer image to the recording medium Q.

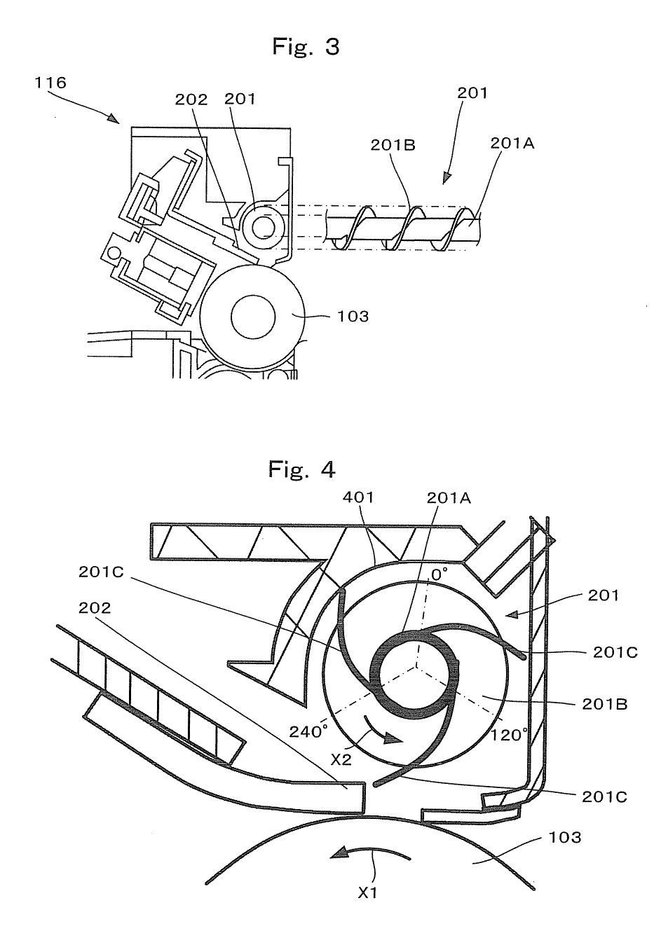

FIG. 3 is an enlarged sectional view of the cleaning unit 116. As shown in FIG. 3, the cleaning unit 116 is disposed above the image carrier 103. The cleaning blade 202 contacts with the outer peripheral curved surface of the image carrier 103 from above the image carrier 103.

In the cleaning unit 116, a recycle unit to return the collected material to the developing unit 106 may be provided at an end of the auger 201. The cleaning unit 116 returns the collected material to the developing unit 106 by the recycle unit, and the developing unit 106 reuses the collected material.

The auger 201 is disposed above the image carrier 103 and the cleaning blade 202. The auger 201 includes an axial body 201A to rotate around a rotation axis parallel to a rotation axis of the image carrier 103, and a spiral conveyance portion 201B as a fin provided spirally on the outer peripheral curved surface of the axial body 201A. Incidentally, in FIG. 3, an after-mentioned conveyance portion 201C is omitted.

FIG. 4 is an enlarged side view of the auger 201. As shown in FIG. 4, the auger 201 includes plural conveyance portions 201C to convey the developer deposited on the cleaning blade 202. When the image carrier 103 rotates in a direction of an arrow X1, the auger 201 rotates in the same direction as the rotation direction of the image carrier 103, that is, a direction of an arrow X2.

When the auger 201 rotates in the reverse direction to the rotation direction of the image carrier 103, the conveyance portion 201C may damage the image carrier 103, or defective cleaning may occur.

When the auger 201 rotates in the same direction as the rotation direction of the image carrier 103, it passes through above the image carrier 103 before the bent shape of the conveyance portion 201C is completely returned. Thus, the conveyance portion does not damage the image carrier 103, and does not push the collected developer between the cleaning blade 202 and the image carrier 103, and accordingly, the defective cleaning does not occur.

The conveyance portions 201C are placed on the axial body 201A while they are shifted from each other by a specified angle around the rotation axis of the axial body 201A. For example, when the first conveyance portion 201C is placed at 0° around the rotation axis of the axial body 201A, the second conveyance portion 201C is placed at 120°, the third conveyance portion 201C is placed at 240°, and the fourth and following conveyance portions 201C are shifted by 120° and are placed.

The conveyance portion 201C is a paper-like body made of high molecular compound. As the high molecular compound, polyethylene terephthalate (PET) is desirable.

When all the conveyance portions 201C are placed in the auger 201 at the same angle around the rotation axis of the axial body 201A, the axial body 201A is bent by the reaction of the pressing force of the conveyance portion 201C applied to an inner wall 401 or the cleaning blade 202. When the axial body 201A rotates while being bent, rattling or defective cleaning is caused.

In the auger 201 of the embodiment, since the conveyance portions 201C are shifted from each other by the specified angle and are placed on the axial body 201A, the axial body 201A is not bent in one direction, and the rattling or defective cleaning does not occur.

Since the spiral conveyance portion 201B is placed spirally, when the conveyance portions 201C are placed as stated above, the placement positions of the respective conveyance portions 201C become positions shifted along the longitudinal direction of the auger 201. Accordingly, the fourth conveyance portion 201C can be placed at the placement angle 0° of the first conveyance portion 201C.

The length of the conveyance portion 201C in the radius direction is longer than the length of the spiral conveyance portion 201B in the radius direction. The length of the conveyance portion 201C in the radius direction is such a necessary and sufficient length that the conveyance portion contacts with the cleaning blade 202, and flips the end of the cleaning blade 202 at the time of rotation.

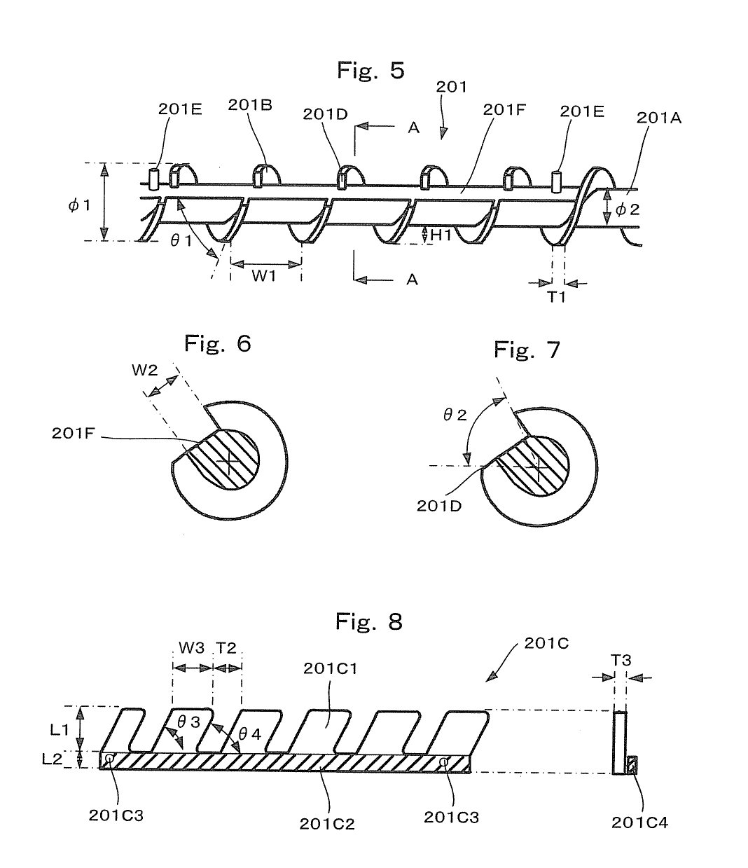

FIG. 5 is an enlarged perspective view of the auger 201. In FIG. 5, the conveyance portion 201C is omitted. As shown in FIG. 5, the auger 201 includes cut portions 201D of the spiral conveyance portion 201B. A specified number of cut portions 201D are provided at the same angle around the rotation axis of the axial body 201A and plural cut portions are provided. Accordingly, the specified number of cut portions 201D among the cut portions are arranged on one straight line.

The respective specified number of cut portions 201D arranged on the one straight line are shifted by a specified angle around the rotation axis of the axial body 201A and are placed on the axial body 201A. For example, when a first specified number of cut portions 201D arranged on one straight line are placed at 0° around the rotation axis of the axial body 201A, a second specified number of cut portions 201D arranged on one straight line is placed at 120°, a third specified number of cut portions 201D arranged on one straight line is placed at 240°, and a fourth or later specified number of cut portions 201D arranged on one straight line are shifted by 120° and are placed.

The axial body 201A includes a plane-shaped flat portion 201F connecting the specified number of cut portions 201D arranged on one straight line. Cylindrical projections 201E are respectively provided on both ends of the flat portion 201F.

Here, an acute angle between the spiral conveyance portion 201B and the axial body 201A is φ1, an interval of the spiral conveyance portion 201B, that is, a pitch is W1, the thickness of the spiral conveyance portion 201B is T1, the diameter of the spiral conveyance portion 201B is φ1, the diameter of the axial body 201A is #2, and the height of the spiral conveyance portion 201B is H1.

FIG. 6 and FIG. 7 are sectional views of the auger 201 taken along line A-A in FIG. 5. As shown in FIG. 6, the flat portion 201F has a width W2. Besides, a cut angle of the cut portion 201D around the rotation axis is an angle of θ2.

FIG. 8 is a front view and a sectional view of the conveyance portion 201C. As shown in FIG. 8, the conveyance portion 201C includes a base portion 201C2 extending in the lateral direction, that is, the longitudinal direction of the auger 201, plural vane portions 201C1 provided at a specified interval T2 and on one side of the base portion 201C2 in the longitudinal direction, and insertion holes 201C3 provided at both ends of the base portion, and has a thickness T3.

The length of the base portion 201C2 in the longitudinal direction is equal to or shorter than the length of the flat portion 201F in the longitudinal direction. A width L2 of the base portion 201C2 is almost equal to the width W2 of the flat portion 201F. The base portion 201C2 has an adhesion layer 201C4 made of an adhesive on the back surface.

It is desirable that a lateral width W3 of the vane portion 201C1 is not larger than the pitch W1 of the spiral conveyance portion 201B, an acute inner angle θ3 among inner angles tangent to the base portion 201C2 is not larger than the acute angle θ1 between the spiral conveyance portion 201B and the axial body 201A, and an acute outer angle θ4 among outer angles tangent to the base portion 201C2 is not less than the acute angle θ1 between the spiral conveyance portion 201B and the axial body 201A.

The vane portion 201C1 has a length L1. It is desirable that the interval T2 is wider than the thickness T1 of the spiral conveyance portion 201B.

The conveyance portion 201C is fixed to the auger 201 in such a manner that the insertion hole 201C3 is fitted to the projection 201E, and the adhesion layer 201C4 is aligned with the flat portion 201F.

Accordingly, the vane portions 201C1 can have a free shape in a range where they do not interfere with the spiral conveyance portion 201B when they are fixed to the auger 201. The vane portion 201C1 desirably has an almost parallelogram-shaped form.

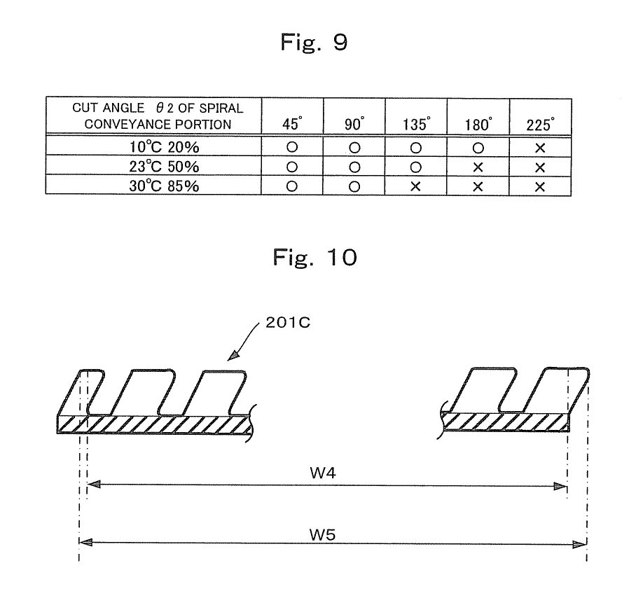

FIG. 9 is a view showing a relation between the cut angle θ2 and the conveyance force of the collected developer. As shown in FIG. 9, it is desirable that the cut angle θ2 is 90° or less in any of the conditions that temperature is 10° C. and humidity is 20%, temperature is 23° C. and humidity is 50%, and temperature is 30° C. and humidity is 85%.

Incidentally, the experiment condition of FIG. 9 is φ1=12 mm, φ2=6 mm, H1=3 mm, W1=14 mm, T1=1 mm, W3=9 mm, T2=5 mm, L1=12 mm, L2=3 mm and T3=50 μm.

FIG. 10 is a view showing the placement range of the conveyance portion 201C provided in the auger 201. As shown in FIG. 10, the conveyance portion 201C is provided in the auger 201 within a range W5 wider than a width W4 of the maximum recording medium on which the image forming apparatus 10 can form an image.

At the time of image formation, a lot of paper powder is generated at both ends of a recording medium. Accordingly, when the conveyance portion 201C is provided within the range W5 wider than the width W4 of the maximum recording medium on which the image forming apparatus 10 can form an image, the paper powder can be efficiently collected.

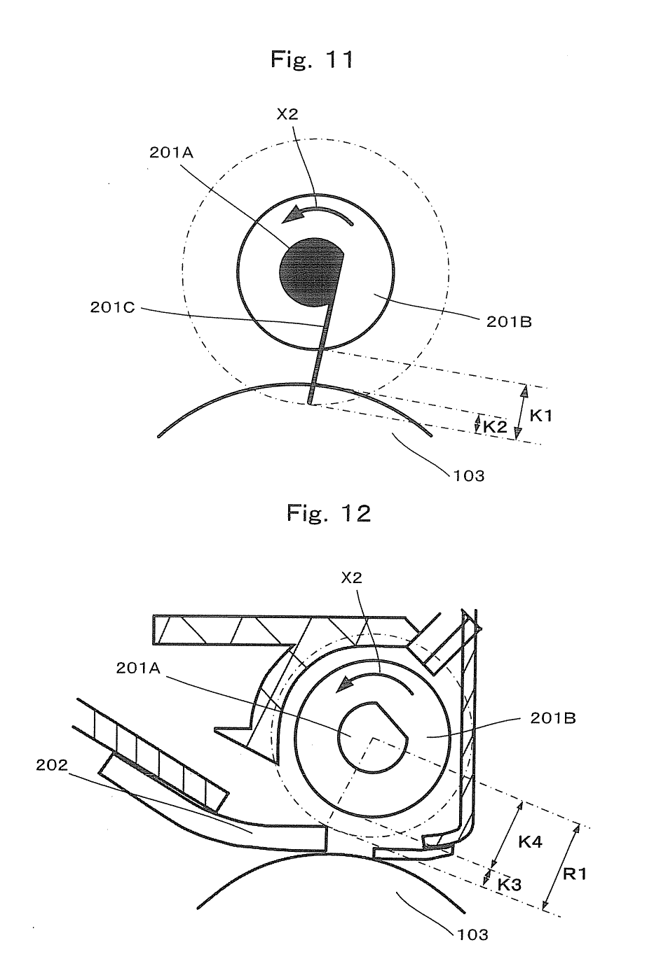

FIG. 11 is a sectional view of the auger 201. As shown in FIG. 11, the length of the conveyance portion 201C protruding from the spiral conveyance portion 201B is K1, and the biting length of the conveyance portion 201C in the rotation radius of the image carrier 103, that is, the length overlapping with the rotation radius of the image carrier 103 is K2.

FIG. 12 is a sectional view of the periphery of the auger 201. As shown in FIG. 12, the shortest distance between the center of the axial body 201A and the cleaning blade 202 is R1, the radius of the spiral conveyance portion 201B is K4, and the distance obtained by subtracting the radius K4 of the spiral conveyance portion 201B from the shortest distance R1 between the center of the axial body 201A and the cleaning blade 202 is K3.

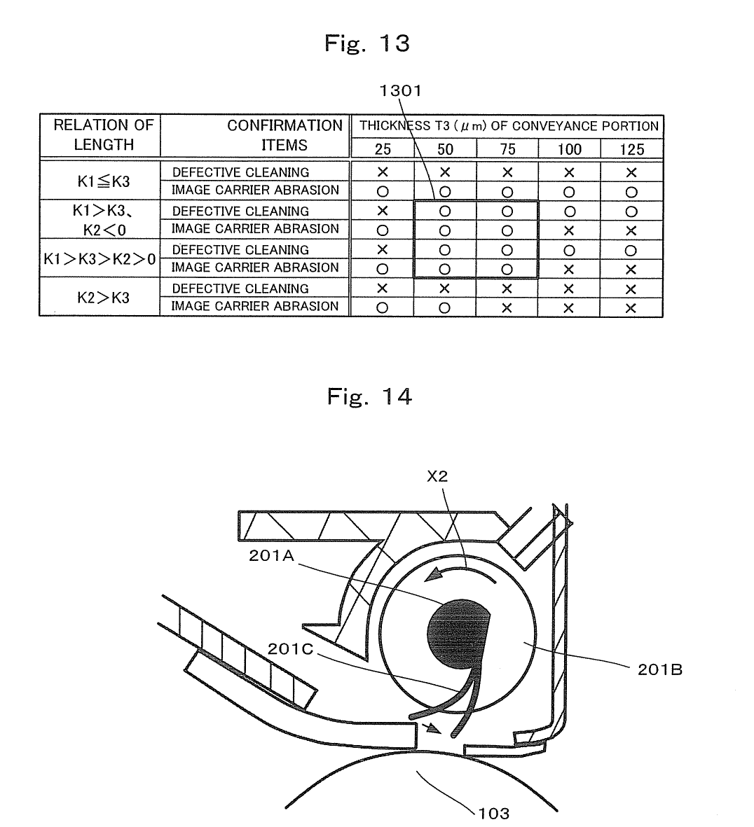

FIG. 13 is a view showing a relation between the length of each part of the conveyance portion 201C and the thickness. As shown in FIG. 13, the range of an optimum range 1301 indicated by a black frame is most desirable. Incidentally, in FIG. 13, a case where toner dropping due to clogging does not occur is indicated by O, and a case where toner dropping occurs is indicated by x. Besides, a case where the increasing rate of abrasion of the image carrier 103 is less than 30% is indicated by O, and a case where it is 30% or more is indicated by x.

Specifically, in the condition of φ1=12 mm, φ2=6 mm, H1=3.5 mm, W1=14 mm, T1=1 mm, W3=9 mm, T2=5 mm and L2=3 mm, the following is obtained.

In the case of K1≦K3, that is, when the conveyance portion 201C does not contact with the cleaning blade 202, even if the conveyance portion 201C is made to have any thickness, toner dropping due to clogging, that is, defective cleaning occurs.

In the case of K1>K3, K2<0, and 50 μm≦T3≦75 μm, that is, when the conveyance portion 201C contacts with the cleaning blade 202 and does not contact with the image carrier 103 when the auger 201 stands still, defective cleaning does not occur, and the abrasion of the image carrier 103 is also within an allowable range.

In the case of K1>K3>K2>0 and 50 μm≦T3≦75 μm, that is, in the case where the conveyance portion 201C contacts with the cleaning blade 202, and although the conveyance portion contacts with the image carrier 103 when the auger 201 stands still, the conveyance portion does not contact with the image carrier 103 at the time of rotation of the auger 201, defective cleaning does not occur, and the abrasion of the image carrier 103 is also within an allowable range.

In the case of K2>K3, that is, when the conveyance portion 201C contacts with the cleaning blade 202 and passes through above the image carrier 103 while being bent, even if the conveyance portion 201C is made to have any thickness, defective cleaning occurs.

FIG. 14 is a view showing the operation of the auger 201 in the optimum range 1301. As shown in FIG. 14, when the auger 201 rotates, the conveyance portion 201C rotates. The conveyance portion 201C contacts with the cleaning blade 202 and is elastically deformed. Further, when the auger 201 rotates, the conveyance portion 201C is flipped by the cleaning blade 202. The conveyance portion 201C passes through above the image carrier 103 before the elastic deformation is restored and the conveyance portion becomes flat, and it does not contact with the image carrier 103.

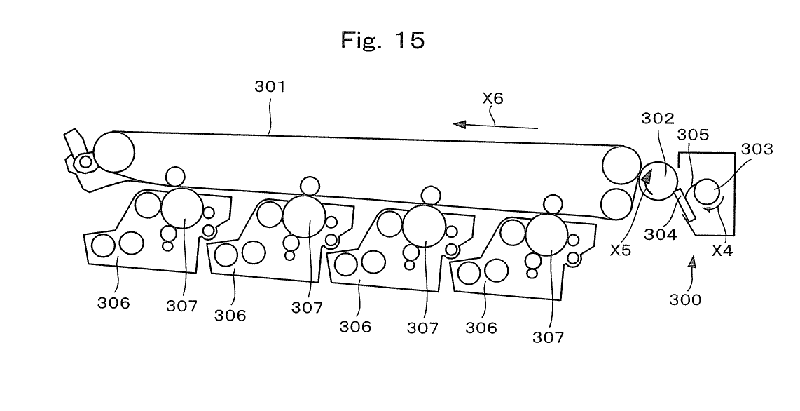

FIG. 15 is a view showing an example of application to a cleaning unit 300 of an image forming portion including an intermediate transfer body. As shown in FIG. 15, when the image forming apparatus 10 is a copying machine, an MFP (Multifunction Peripheral) or the like, the image forming portion includes an intermediate transfer body 301 such as a transfer belt.

The image forming apparatus 10 reads an original document by a scan unit, and converts it into an electric signal. The converted electric signal is processed by an image processing portion, and an electrostatic latent image is formed on an image carrier 307 by a laser light source. The developing unit 306 supplies a developer to the image carrier 307, and a developer image is formed.

The developer image is transferred to the intermediate transfer body 301 and is conveyed, and is transferred to a recording medium by a transfer roller 302.

When the recording medium is not conveyed, the developer image adheres to the transfer roller 302. The adhered developer is collected by the cleaning unit 300.

The cleaning unit 300 includes a cleaning blade 304 which contacts with the transfer roller 302 and peels the developer, and an auger 303. The auger 303 includes a conveyance portion 305. The transfer roller 302 rotates in a direction of an arrow X5, and the auger 303 rotates in the same direction as the rotation direction of the transfer roller, that is, a direction of an arrow X4.

The structure, operation and function of the auger 303 and the conveyance portion 305 are the same as the structure, operation and function of the auger 201 and the conveyance portion 201C.

As described above, the image forming apparatus 10 of the embodiment includes the cleaning unit 116 including the cleaning blade 202 which contacts with the image carrier 103 and peels the collected material on the image carrier 103, and the auger 201 to convey the peeled collected material in the direction parallel to the rotation axis of the image carrier 103.

The auger 201 includes the axial body 201A to rotate around the rotation axis parallel to the rotation axis of the image carrier 103, the spiral conveyance portion 201B spirally provided on the outer peripheral curved surface of the axial body 201A, and the conveyance portion 201C.

The conveyance portion 201C includes the base portion 201C2 extending in the lateral direction, the plural vane portions 201C1 provided on one side of the base portion 201C2 in the longitudinal direction at the specified interval T2, and the insertion holes 201C provided in both the ends of the base portion.

When the auger 201 rotates, the conveyance portion 201C rotates. The conveyance portion 201C contacts with the cleaning blade 202, and is elastically deformed. Further, when the auger 201 rotates, the conveyance portion 201C is clipped by the cleaning blade 202. The conveyance portion 201C passes through above the image carrier 103 before the elastic deformation is restored and it becomes flat, and the conveyance portion does not contact with the image carrier 103.

Accordingly, there is an effect that also when the cleaning device of the embodiment is applied to the image forming apparatus 10 in which the cleaning device is disposed above the rotation axis of the image carrier, the cleaning effect can be sufficiently obtained.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
an image carrier to carry an electrostatic latent image;
a developing unit to supply a developer to the image carrier, and
a cleaning unit which includes a cleaning blade to contact with the image carrier and to peel the developer, an auger including a spiral conveyance portion formed into a spiral shape and to convey the developer peeled by the cleaning blade, and a plurality of conveyance portions provided in the auger, having a plurality of vane portions provided to be spaced from each other at specified intervals in a longitudinal direction of a base portion extending in a longitudinal direction of the auger, and having a length to contact with the cleaning blade.

2. The apparatus of claim 1, wherein
the spiral conveyance portion has cut portions partly,
the auger includes an axial body to support the spiral conveyance portion around a rotation axis, and a plane-shaped flat portion of the axial body connecting the cut portions, and
the conveyance portions are placed to prevent the vane portions, together with the base portion and the flat portion, from interfering with the spiral conveyance portion.

3. The apparatus of claim 2, wherein the conveyance portions are placed on the axial body while being shifted from each other by a specified angle around a rotation axis of the axial body.

4. The apparatus of claim 1, wherein the auger rotates in a same direction as a rotation direction of the image carrier.

5. The apparatus of claim 1, wherein
the cleaning unit returns the collected developer to the developing unit, and
the developing unit reuses the collected developer.

6. The apparatus of claim 1, wherein the conveyance portions are provided in a range wider than a width of a maximum recording medium on which an image can be formed in the longitudinal direction of the auger.

7. The apparatus of claim 1, wherein a thickness of the conveyance portion is 50 μm or more and 75 μm or less.

8. The apparatus of claim 1, wherein the conveyance portion has a length that the conveyance portion contacts with the cleaning blade and does not contact with the image carrier when the auger stands still.

9. The apparatus of claim 2, wherein
when a length of the conveyance portion protruding from the spiral conveyance portion is K1, a length of the conveyance portion overlapping with a rotation radius of the image carrier is K2, and a distance obtained by subtracting a radius of the spiral conveyance portion from a shortest distance between a center of the axial body and the cleaning blade is K3,
the conveyance portion satisfies K1>K3>K2>0, and
a cut angle of the cut portion around the rotation axis is 90° or less.

10. The apparatus of claim 1, wherein the cleaning unit is placed above a rotation axis of the image carrier.

11. An image forming apparatus comprising:
an image carrier to carry an electrostatic latent image;
a developing unit to supply a developer to the image carrier to form a developer image;
an intermediate transfer body to transfer the developer image;
a transfer roller to transfer the developer image from the intermediate transfer body to a recording medium; and
a cleaning unit which includes a cleaning blade to contact with the transfer roller and to peel the developer, an auger including a spiral conveyance portion formed into a spiral shape and to convey the developer peeled by the cleaning blade, and a plurality of conveyance portions provided in the auger, having a plurality of vane portions provided to be spaced from each other at specified intervals in a longitudinal direction of a base portion extending in a longitudinal direction of the auger, and having a length to contact with the cleaning blade.

12. A developer collecting method of an image forming apparatus, comprising:
peeling a developer by bringing a cleaning blade into contact with an image carrier;
conveying the developer peeled by the cleaning blade by an auger having a spirally formed spiral conveyance portion; and
conveying the developer deposited on the cleaning blade by a plurality of conveyance portions which are provided in the auger, include a plurality of vane portions provided to be spaced from each other at specified intervals in a longitudinal direction of a base portion extending in a longitudinal direction of the auger, and have a length to contact with the cleaning blade.

13. The method of claim 12, wherein
cut portions are provided at a part of the spiral conveyance portion,
an axial body to support the spiral conveyance portion around a rotation axis, and a plane-shaped flat portion of the axial body connecting the cut portions are provided in the auger, and
the conveyance portions are placed to prevent the vane portions, together with the base portion and the flat portion, from interfering with the spiral conveyance portion.

14. The method of claim 13, wherein the conveyance portions are placed on the axial body while being shifted from each other by a specified angle around the rotation axis of the axial body.

15. The method of claim 12, wherein the auger rotates in a same direction as a rotation direction of the image carrier.

16. The method of claim 12, wherein
a cleaning unit returns the collected developer to a developing unit, and
the developing unit reuses the collected developer.

17. The method of claim 12, wherein the conveyance portions are provided in a range wider than a width of a maximum recording medium on which an image can be formed in the longitudinal direction of the auger.

18. The method of claim 12, wherein the conveyance portions are formed to have a thickness of 50 μm or more and 75 μm or less.

19. The method of claim 12, wherein the conveyance portion is formed to have a length to allow the conveyance portion to contact with the cleaning blade and to inhibit the conveyance portion from contacting with the image carrier when the auger stands still.

20. The method of claim 13, wherein
when a length of the conveyance portion protruding from the spiral conveyance portion is K1, a length of the conveyance portion overlapping with a rotation radius of the image carrier is K2, and a distance obtained by subtracting a radius of the spiral conveyance portion from a shortest distance between a center of an axial body and the cleaning blade is K3,
the conveyance portion is formed to satisfy K1>K3>K2>0, and
the auger is formed to cause the cut portion to have a cut angle of 90° or less around the rotation axis.
